(19) United States
(12) Patent Application Publication
(10) Pub. No.: US 2007/0237146 A1
(43) Pub. Date: Oct. 11, 2007

(54) Methods and apparatus for modeling and synthesizing packet processing pipelines

(76) Inventors: Ilija Hadzic, Millington, NJ (US); Cristian P. Soviani, New York, NY (US)

Correspondence Address: Ryan, Mason & Lewis, LLP, Suite 205, 1300 Post Road, Fairfield, CT, 06824, US

(21) Appl. No.: 11/394,749

(22) Filed: Mar. 31, 2006

(51) Int. Cl. H04L 12/56

(52) U.S. Cl. 370/392

(57) ABSTRACT

Methods and apparatus are provided for modeling and synthesizing circuits for packet processing that transform one or more fields of a packet. A circuit for packet processing that transforms one or more fields of a packet is modeled by representing the transformation using a packet editing graph having at least one node. The transformation can comprise one or more of adding, removing, modifying and maintaining the at least one field of a packet header. A circuit for packet processing that transforms one or more fields of a packet is synthesized by synthesizing a control finite state machine based on the packet editing graph, wherein the packet editing graph represents the circuit for packet processing. Elements of the packet editing graph are transformed in a predefined manner into corresponding elements of the synthesized circuit for packet processing.

### FIELD OF THE INVENTION

The present invention relates to techniques for modeling and synthesizing circuits for packet processing and, more particularly, to methods and apparatus for modeling and synthesizing circuits for packet processing using a packet editing graph.

### BACKGROUND OF THE INVENTION

Packet switches, routers or other packet forwarding elements are a basic building block in any data communication network. The primary role of a packet switch is to forward packets from one port to another port based on the contents of each packet, specifically header data at the beginning of each packet. As part of this forwarding operation, packets are classified, queued, modified, transmitted, or dropped.

The forwarding algorithms used in most switches are relatively simple by design to facilitate efficient hardware implementations. However, performance considerations make the forwarding algorithms tedious to code in a standard Register Transfer Logic (RTL) flow. In particular, hardware implementations of forwarding algorithms are typically deeply pipelined circuits that operate on wide buses (e.g., 128 or 256 bits) and interact with high-speed first-in-first-out (FIFO) buffers through a rigid hand-shaking protocol. Thus, their control finite-state machines are complicated and difficult to write correctly.

A need therefore exists for improved techniques for synthesizing such packet processing circuits.

### SUMMARY OF THE INVENTION

Generally, methods and apparatus are provided for modeling and synthesizing circuits for packet processing that transform one or more fields of a packet. According to one aspect of the invention, a circuit for packet processing that transforms one or more fields of a packet is modeled by representing the transformation using a packet editing graph having at least one node. The transformation can comprise one or more of adding, removing, modifying and maintaining the at least one field of a packet header. The packet editing graph can have at least one conditional node which has a plurality of output branches, wherein a value of at least one of the fields is determined by selecting a corresponding one of the output branches based on a value of a predicate applied to the conditional node. The packet editing graph can also include one or more of arithmetic and logical operators and connections among one or more of inputs, operators and outputs.

According to another aspect of the invention, a circuit for packet processing that transforms one or more fields of a packet is synthesized by synthesizing a control finite state machine based on a packet editing graph having at least one node, wherein the packet editing graph represents the circuit for packet processing. Nodes in the packet editing graph are transformed into registers. Conditional nodes in the packet editing graph are transformed into a multiplexer controlled by the control finite state machine. Arithmetic and logical operators in the packet editing graph are transformed into one or more combinatorial circuits. A wrapper function is also synthesized that surrounds the synthesized core, wherein the wrapper function identifies packet boundaries using one or more signal flags.

A more complete understanding of the present invention, as well as further features and advantages of the present invention, will be obtained by reference to the following detailed description and drawings.

### BRIEF DESCRIPTION OF THE DRAWINGS

FIG. 1 is a block diagram of an exemplary packet switch architecture;

FIG. 2 shows a section of a packet processing pipeline that edits a Virtual Local Area Network (VLAN) tag of an exemplary Ethernet packet and adds a Multi Protocol Label Switching (MPLS) label;

FIG. 3 is a flow chart describing an exemplary packet processor synthesis process incorporating features of the present invention;

FIG. 4 illustrates an exemplary Packet Editing Graph (PEG) model for the MPLS push module of FIG. 2;

FIG. 5 illustrates an exemplary core module wrapped in a wrapper module;

FIG. 6 illustrates exemplary pseudo code for one of the synthesis steps for one embodiment of the present invention;

FIG. 7 illustrates a result of a packet restructuring procedure performed on the MPLS example of FIG. 3;

FIG. 8 illustrates a packet map that supplements the fixed-word size PEG of FIG. 7 with read cycle indices and delay bubbles;

FIG. 9 illustrates an example of scheduling inside a read cycle index;

FIG. 10 illustrates exemplary pseudo-code for a bubble-insertion algorithm;

FIG. 11 shows the packet map of FIG. 8 translated into an FSM; and

FIG. 12 is a block diagram of a computer-aided design system 1200 that can implement the processes of the present invention.

### DETAILED DESCRIPTION

The present invention provides a high-level synthesis technique for packet editing blocks. Although the present invention is illustrated herein in the context of Field Programmable Gate-Arrays (FPGAs), the techniques of the present invention could also be adapted for use with application specific integrated circuits (ASICs), as would be apparent to a person of ordinary skill in the art. FIG. 1 is a block diagram of an exemplary packet switch architecture 100. As shown in FIG. 1, the exemplary packet switch architecture 100 comprises an ingress circuit for packet processing 110, an ingress traffic manager 120, a switching fabric 130, an egress traffic manager 140, and an egress circuit for packet processing 150, in a known manner. The ingress circuit for packet processing 110, ingress traffic manager 120, egress traffic manager 140, and egress circuit for packet processing 150 comprise a line card 180. Typically, there are multiple line cards in a system, and their function is to provide the network interface, make forwarding and scheduling decisions and modify and queue packets. The switching fabric 130 provides means for interconnecting multiple line cards 180 in a larger system and forwarding packets, from one line card 180 to another.

As used herein, the term “line card” does not necessarily represent a physical card or a circuit pack in the system (i.e., there could be switches that divide the functionality of a “line card” into multiple cards and daughter cards. Further, there could be switches that capture a switch fabric along with multiple line cards onto one physical card, or switches that do not have a switch fabric at all (e.g., one line card with multiple ports or multiple line cards with full mesh connection on the backplane). All of these types of partitioning (and beyond) would be apparent to a person of ordinary skill in the art and the disclosed synthesis methods apply regardless of the physical system partition.

As discussed hereinafter, the synthesis techniques of the present invention can be applied to designing the line cards 180, which provide network interfaces, make forwarding and scheduling decisions, and, most critically, modify packets according to their contents. According to various aspects of the invention, a technique is provided for modeling modules or algorithms that transform input packets into output packets and a synthesis procedure is also provided that translates the packet transformation algorithms into efficient synthesizable Hardware Description Language (HDL), such as a Very High Speed Integrated Circuit (VHSIC) HDL (VHDL) or Verilog code. As used herein, a packet “transformation” includes inserting a field, removing a field, changing the contents of a field, and maintaining the existing contents of a field (a “no operation”). The disclosed techniques produce standalone packet editing blocks that are easily connected in pipelines. The modeling techniques of the present invention are easier to write and maintain than traditional RTL descriptions. Maintainability of already-deployed systems is becoming increasingly important with the widespread use of FPGAs that allow hardware components of the system to be updated in the field in the same manner as the software.

Circuits for Packet Processing and Packet Editing

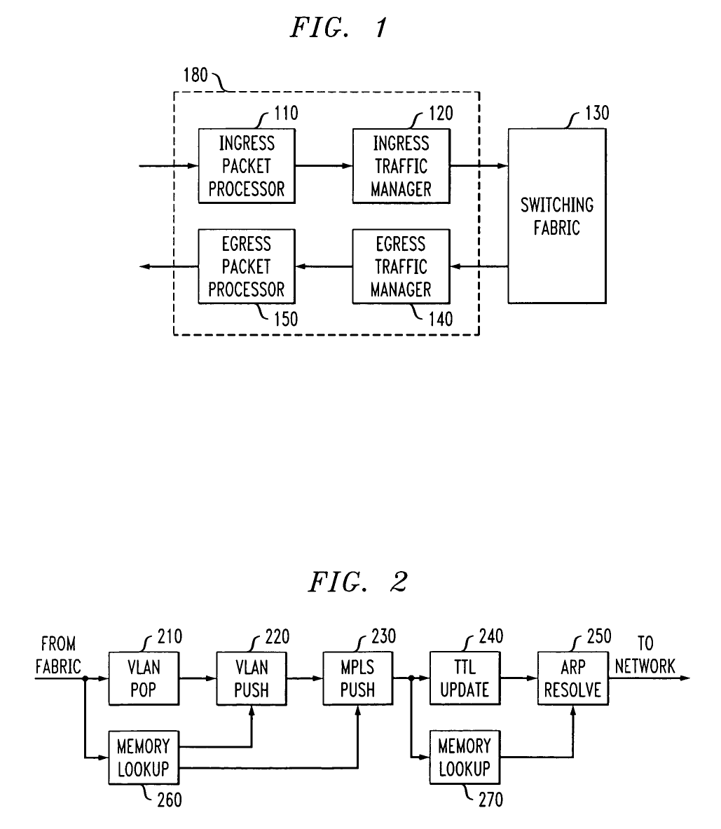

The disclosed synthesis techniques build components in the ingress (input) and egress (output) circuits for packet processing 110, 150, such as the exemplary flow shown in FIG. 2. A circuit for packet processing 110, 150 can be thought of as a functional block that transforms a stream of input packets into output packets. In practice, these transformations consist of adding, removing and modifying fields from the packet header. Some headers may be internal to the switch (i.e., used only to communicate information between circuits for packet processing 110, 150); referred to as control headers.

Circuits for packet processing 110, 150 perform complex tasks but are usually designed by composing simpler functions in a graph whose topology reflects the packet flow. This model has been used for software implementations on hosts and on switches. See, e.g., S. O'Malley and L. L. Peterson, “Dynamic Network Architecture,” ACM Transactions on Computer Systems, 10(2), 110-143 (1992); or E. Kohler et al., “The Click Modular Router,” ACM Transactions on Computer Systems, 18(3), 263-297 (August 2000). Alternatively, a pool of task-specific threads may process the same packet in parallel without actually moving the packet. See, G. Brebner et al., “Hyper-Programmable Architecture for Adaptable Networked Systems,” Proc. of the 15th Int'l Conf. on Application-Specific Architectures and Processors (2004).

A restricted protocol graph model is employed that prohibits loops, so the packet flow through the processors 110, 150 is unidirectional. This restriction simplifies the implementation without introducing major limitations. For example, the loops in the IP router described by Kohler et al. only handle exceptions. This is better done by a control processor, i.e., outside the packet processing pipeline. It is noted, however, that such loops can be manually modeled, using existing techniques.

While the logical flow can fork and join, the disclosed embodiment employs linear pipelines. Multiple logic flows can be achieved, for example, by setting flags in the control header that instruct later stages to pass the packet intact. Thus, the disclosed techniques can emulate a logical flow having forks and joins using a linear pipeline. For example, consider a module A that branches to two modules 1 and 2, and then rejoins at module B, with module 1 processing a packet flow a and module 2 processing a packet flow b. A linear pipeline can be established with modules A, 1, 2 and B in series, and module 1 ignoring packet flow b and module 2 ignoring packet flow a. A non-linear pipeline would be more complicated and could only improve latency, not throughput. Finally, if the packet needs to be dropped or forwarded to the control processor, flags are set in the control header and the action is performed at the end of the pipeline. In this manner, all processing elements see all packets that enter the pipeline in the same order. Switches often do reorder packets, but this is usually done by the traffic manager 120, 140.

FIG. 2 shows a section of a packet processing pipeline that edits the Virtual Local Area Network (VLAN) tag of an Ethernet packet and adds a Multi Protocol Label Switching (MPLS) label. It is assumed that some previous stage has performed flow classification and prepended the control header with unique packet flow identification (Flow ID) to the packet. The packet is modified as it flows from left to right.

Both the VLAN push 220 and MPLS push 230 modules insert additional headers after the Ethernet header, while the Time-To-Live (TTL) update 240 and Address Resolution Protocol (ARP) resolution 250 modules only modify existing packet fields. The VLAN pop module 210 removes a header from the packet. While this pipeline is fairly simple, a realistic switch only performs more such operations, not more complicated ones.

Thus, packet processing amounts to adding, removing, and modifying fields. Even the flow classification stage, which typically involves a complex search operation, ultimately just produces a modified header (i.e., a control header with a Flow ID field). These operations are referred to as “packet editing,” which is the fundamental building block of a circuit for packet processing.

In addition to the main pipeline, FIG. 2 shows two memory lookup blocks 260, 270. These blocks 260, 270 store descriptors that define how the headers should be edited (e.g., how many MPLS labels to add and what values to use). In the example of FIG. 2, the Flow ID indexes into the memory from which the descriptors are retrieved. In general, a memory lookup module 260, 270 can be any component that takes selected packet fields and produces data used by a downstream processing element (e.g., an IP address search operation, present in all IP routers, is a form of generalized memory lookup). Flow classification can thus be implemented as a combination of a memory lookup and packet editing.

As used herein, the term “memory lookup” shall include, for example, the presentation of an address to the memory and memory returning the content of the location, as well as the presentation of a search key to the memory and having the memory search through some internal data structure to retrieve data associated with the presented key (often referred to as a Content Addressable Memory (CAM) or an Associative Memory). In addition, a “memory lookup” can include, for example, a module telling the external block (“memory”) that it saw a packet belonging to a certain flow (i.e., presents a binary number that uniquely identifies a flow). Rather than storing some simple data associated with that address, a memory could store information about the arrival history of that flow and the data returned could be information on whether or not packets belonging to the flow are coming too frequently. This type of “memory,” along with a module synthesized using the disclosed method, can then be used to implement a traffic policing function.

Modules that use memory lookup rely on a previous pipeline stage to issue the search request, which will be processed in parallel with later pipeline stages to hide memory latency. The disclosed synthesis techniques do not synthesize memory lookup blocks, but can generate search requests and consume search results. Because the exemplary pipeline of FIG. 2 neither reorders nor drops packets, simple FIFOs work for interfacing memory lookup modules to the blocks.

Hence, circuits for packet processing are modeled as a linear pipeline of processing elements with four types of interfaces: (i) input from the previous pipeline stage, (ii) output to the next stage, (iii) search requests to memory, and (iv) search results from memory. The processing element must be capable of generating the search request and editing the packet based on the packet content and the data structure retrieved from memory.

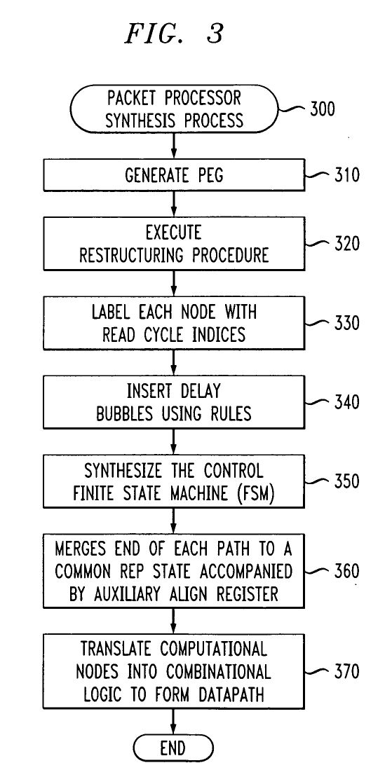

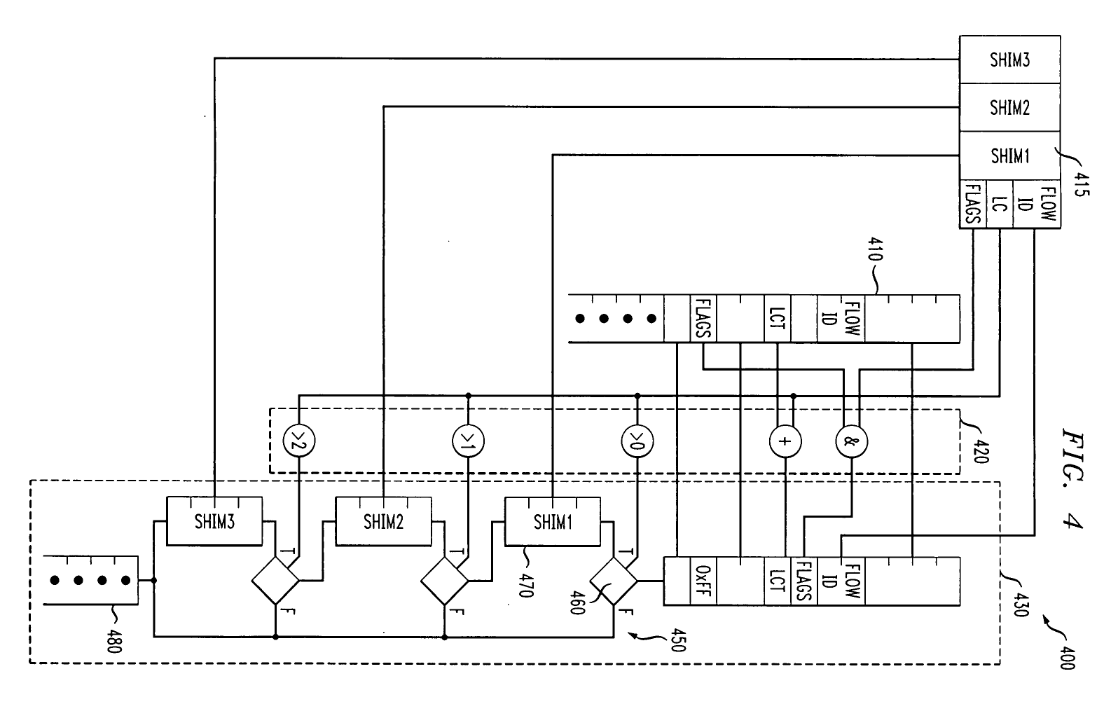

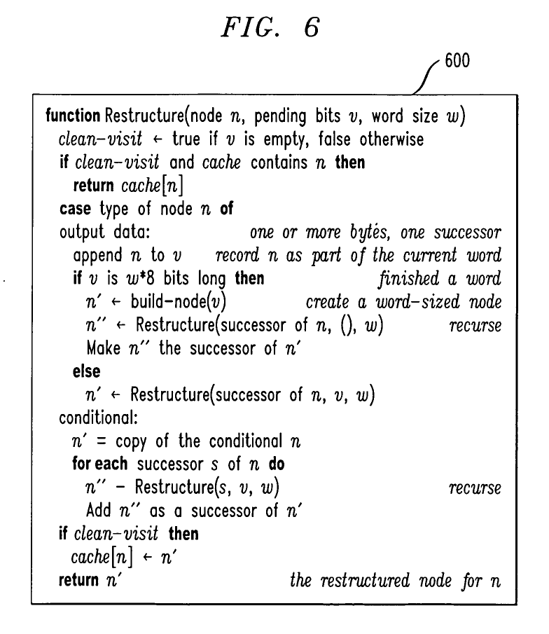

FIG. 3 is a flow chart describing an exemplary circuit for packet processing synthesis process 300 incorporating features of the present invention. As shown in FIG. 3, the circuit for packet processing synthesis process 300 initially generates a Packet Editing Graph PEG) during step 310. An exemplary PEG is discussed below in conjunction with FIG. 4. Thereafter, the PEG is restructured during step 320 using a restructuring procedure 600 (FIG. 6). Each node is then labeled during step 330 with read cycle indices, and then delay bubbles are inserted during step 340 using predefined rules.

A control finite state machine (FSM) is synthesized during step 350. The end of each path is merged during step 360 to a common REP state that is accompanied by an auxiliary align register. Finally, computational nodes are translated during step 370 directly into combinational logic to form the datapath. Each of these steps is discussed in further detail below.

Packet Editing Graph

While the behavior of a single node in a packet editing pipeline could be modeled, for example, at the register-transfer level, doing so would be awkward for these deeply pipelined circuits that must operate on many bits in parallel. Instead, the present invention employs a Packet Editing Graph (PEG) as an abstract model for describing such nodes. This type of model is easier to design and modify (because it hides implementation details), and it can be synthesized into very efficient circuitry.

FIGS. 4 through 6 illustrate three steps for synthesizing a PEG model for the MPLS push module 230 of FIG. 2. FIG. 4 illustrates the initial specification of the MPLS push module 230 of FIG. 2. The MPLS protocol adds a label to the beginning of the packet that acts as a shorthand for other header fields that uniquely define a packet flow. When the packet arrives at another MPLS-enabled switch, the receiving MPLS-enabled switch uses separate, faster rules to forward the packet. The MPLS push module 230 inserts between zero and three such MPLS labels according to a descriptor coming from the memory lookup 260. The MPLS push module 230 also updates the label count (LCT) field in the control header by adding the number of additional labels pushed, replaces the Flow ID field with the one from the descriptor and updates various flags in the control header. Replacing the Flow ID essentially results in mapping from a set of MPLS tunnels to the set of next-hop destinations. The mapping can be many-to-one and the new Flow ID will be used by the ARP resolution module 250 to determine the destination Ethernet address.

A PEG is an acyclic, directed graph 400 consisting of four classes of elements;

inputs 410, 415 (the packet 410 itself and data 415 from the memory lookup block 260, drawn as rectangles in FIG. 4), arithmetic and logical operators 420 (the circular nodes in the middle of FIG. 4), outputs 430 (an output packet map, shown on the right side of FIG. 4, and data used to generate memory lookup requests, not shown in the example of FIG. 4) and the various connections among the inputs 410, operators 420 and outputs 430. In FIG. 4, time flows from top to bottom and data flows from left to right.

The packet map 450 (i.e., the control-flow graph on the right) is an important aspect of a PEG. The bits of the output packet are assembled by starting at the top of this graph 450 and traversing the graph downward. Diamond-shaped nodes, such as node 460, are conditionals. Output packets are generated by proceeding down the left or right branch of each conditional node based on the value of the predicate fed to conditionals. In this manner, bits from the output packet can be inserted and deleted. The final-node 480, marked with dots, copies the remainder of the input packet to the output.

Synthesis Procedure

A significant challenge in synthesizing a circuit from a PEG 400 is converting the flat, bit-level PEG specification into the sequential word-level implementation needed for performance. This can be non-trivial because operand and result bit fields are generally not on word boundaries, and some results may depend on operands that appear later in the input packet. Moreover, a PEG allows conditional insertions and removals, so there is not always a simple mapping between the word in which an input byte appears and the word in which it appears in the output.

The disclosed synthesis procedure analyzes the PEG 400, establishes the necessary mapping, and builds both a datapath and a controller that produces the required behavior.

A. Wrappers and the Module Interface

The present invention creates synthesizable RTL for an element by instantiating a hand-written wrapper around the core synthesized from a PEG 400. The wrapper adapts the simple core interface to the particular protocol used between blocks and buffers.

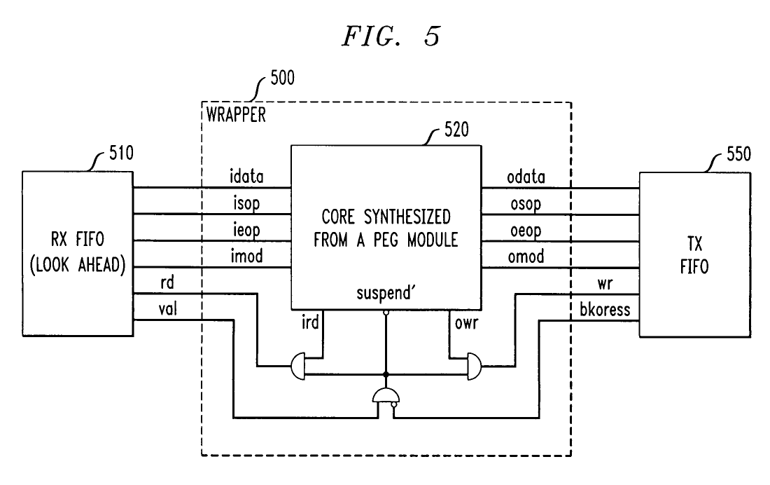

FIG. 5 illustrates a typical wrapper 500 around a core module 520. For simplicity, FIG. 5 does not show optional memory input/output ports, although they are also handled by the wrapper 500. As they transfer exactly one word per packet, the core sees the input port as a parameter, and the output port as a register. The wrapper 500 ensures the correct operation between packets. As shown in FIG. 5, the wrapper 500 translates data between a receiver FIFO 510 and a transmitter FIFO 550.

Cores, such as the core 520, receive and send packets over a w-byte parallel interface (w equal to 8 or 16 is typical with existing technologies). The module 520 sees the input packet as a sequence of w-byte words arriving sequentially on the idata port of FIG. 5. Similarly, the output is generated as a sequence of w-byte words on the odata port. Packet boundaries are indicated by three flags on each port: sop indicate the start of a packet, eop indicates the end of the packet, and the mod signal indicates the number of valid bytes in the last word of the packet (i.e., when eop is asserted) since the number of bytes in a packet is not necessarily a multiple of the word size.

In addition, as shown in FIG. 5, a core communicates through three more signals processed by the wrapper 500. The ird and owr signals request data from the input and indicate when data are written to the output. The suspend input instructs the module 520 to stall for a cycle. The wrapper 500 in FIG. 5 stalls the module 520 when input data are not available or when the output cannot accept new data.

For modules 520 having auxiliary inputs, such as memory reads, the synthesized core 520 assumes that input data is present and stable at that input all the time during the currently processed packet. Thus, for the core 520, an auxiliary input is seen as a constant parameter (i.e., one packet having one value).

It it thus the duty of the synthesized wrapper 500 to perform the following:

a. stall the core if the auxialiry input data has not arrived yet; and

b. switch the input value from the current value to the next value exactly when the core 520 switches from processing the current packet to the next packet.

For modules having auxiliary outputs, such as memory writes, the core 520 writes to the auxiliary output as soon as the data to be written is computed. The core 520 assumes that it is possible to write the data. Thus, it is the duty of the wrapper 500 to stall the core 520 if the receiver cannot accept the data (i.e., the module is back-pressured).

B. Splitting Data into Words

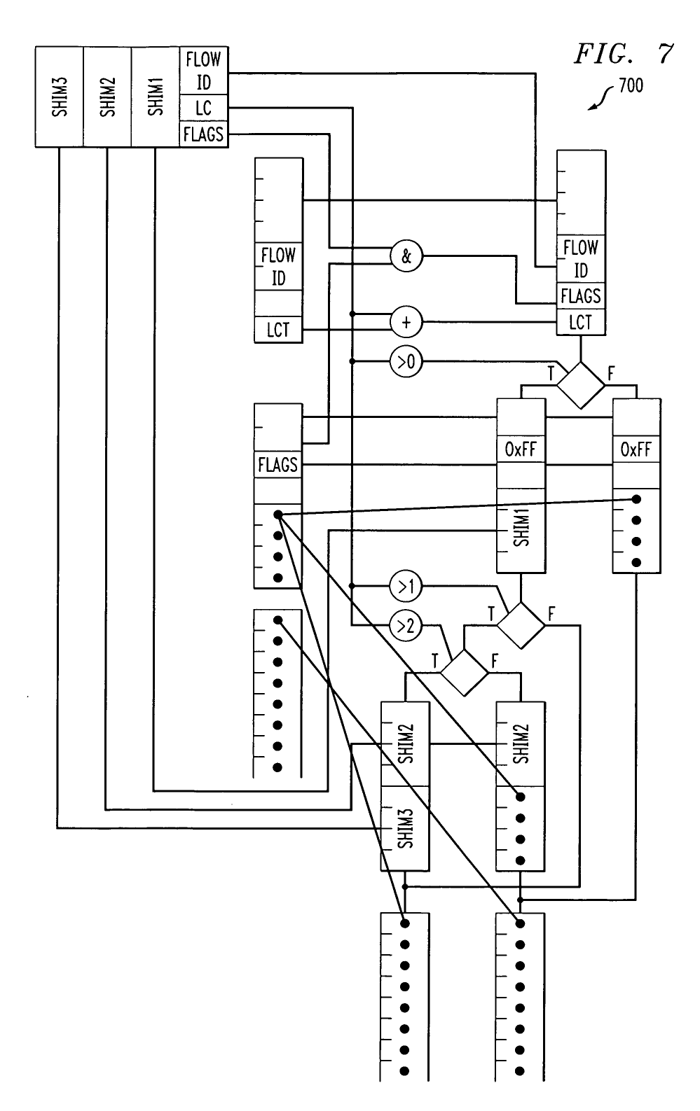

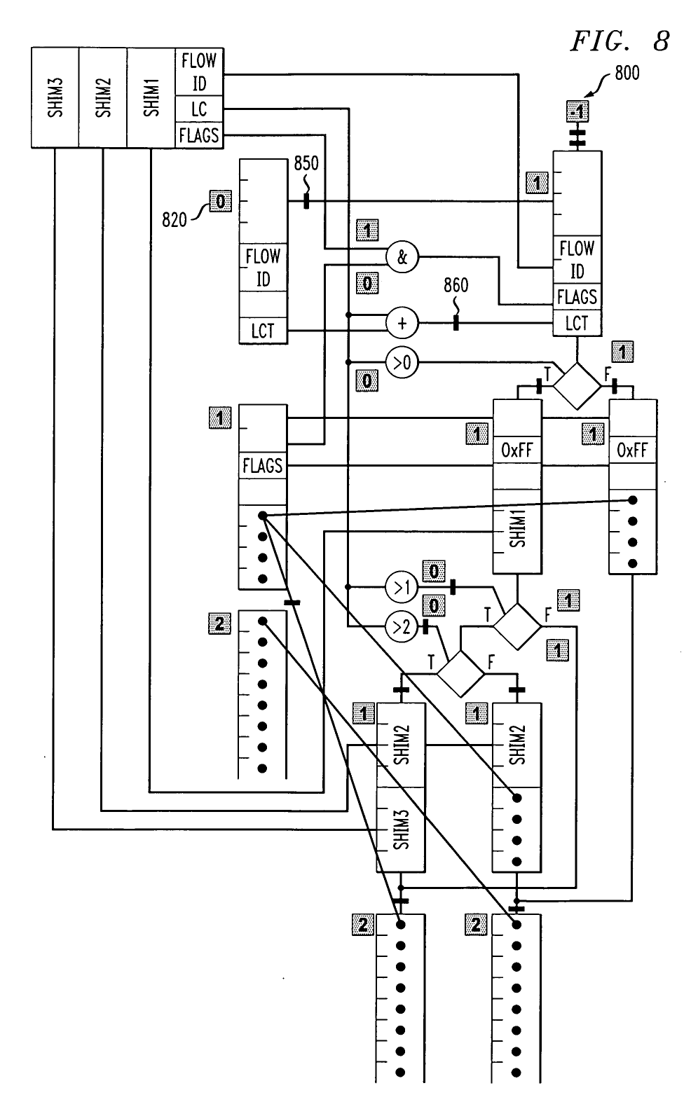

FIG. 6 illustrates exemplary pseudo-code for a packet restructuring procedure 600 incorporating features of the present invention. The synthesis procedure begins by dividing the input and output packets on word boundaries using the packet restructuring procedure 600. Dividing the input packet is straightforward; reshaping the output packet map is complicated because of conditionals. FIG. 7 shows the result of this procedure performed on the MPLS example of FIG. 3, where the nodes associated with the output packet are split into a fixed size, such as 64-bit words.

The packet map is restructured so that conditions are only checked at the beginning of each word. This guarantees that only complete words are generated in each cycle except the last (a special case). For example, the >0 condition in FIG. 4 has been moved four bytes earlier (to the beginning of the second word) in FIG. 7 and the intervening four bytes have been copied to the two branches under the now-earlier conditional to maintain I/O behavior.

The algorithm in FIG. 6 recursively walks the packet map to build a new map whose nodes are all w bytes long (the word size). Each node is visited with a vector v that contains bits that are “pending” in the current word. Output nodes are added to this vector until w×8 bits are accumulated, at which point a new output node is created by the function, build-node, which assembles the saved bits in v. The algorithm 600 handles conditionals by copying the condition to a new node n′, which is placed at the beginning of the current word, and visiting the two successors under the conditional. The same vector v is copied to each recursive call, effectively duplicating the rules for the bits that appeared before the conditional in the current word.

The restructuring procedure 600 has the potential of generating an exponentially large tree, but in practice this is not a problem because protocols are designed to avoid it; furthermore, the process 600 reconverges whenever possible. For example, there are four different paths in FIG. 7; but they ultimately lead to only two different states; the one- and three-label cases reconverge as they require the same alignment with respect to the input packet; similarly for the zero- and two-label cases.

Reconvergence is handled by maintaining a cache of nodes that can be reused safely. If a node visit is “clean,” that is, the pending vector is empty, the cache is checked for a previous visit and reused if possible.

C. Assigning Read Cycle Indices

After splitting the packet map into word-size chunks using the restructuring procedure 600 of FIG. 6, the disclosed procedure labels each node with the logical cycle in which its data becomes available. FIG. 8 illustrates a packet map 800 that supplements the fixed-word size PEG 700 of FIG. 7 with read cycle indices and delay bubbles. The read cycle indices, such as the read cycle indices 810, 820, are drawn in black boxes in FIG. 8. The read cycle indices are intuitively clock cycles, but actually an index may map to several clocks if the controller causes a stall.

The first input word index is zero, the second is one, and so forth. The remaining word indexes are computed by observing the obvious causality relationship: the index of a node is the highest index of all its predecessors. Constant nodes and memory inputs, assumed to be present in all cycles, are therefore ignored.

D. Scheduling

Once the read cycle indices are assigned in the manner shown in FIG. 8, “bubbles”, such as bubbles 850, 860, are inserted into the modified PEG 800 that correspond roughly to pipeline stages. The delay bubbles are shown in FIG. 8 as black rectangles. The delay bubbles are inserted according to the following rules:

1. If two indices differ by k>0, at least k bubbles are needed between them.

2. Any two output nodes in the packet map, even with the same index, require at least one bubble between them.

In FIG. 8, two delay bubbles were inserted between the topmost node and the first output node because the difference between their indices is two. This follows the first rule. Intuitively, the first word cannot be output in cycle 0, because it depends on the flags field, which becomes available in cycle 1. Following the second rule, bubbles were also added after the first conditional because these arcs are between two output nodes. Intuitively, these bubbles are necessary because although the information needed to construct the second word is available in the first cycle, writing two words simultaneously is impossible.

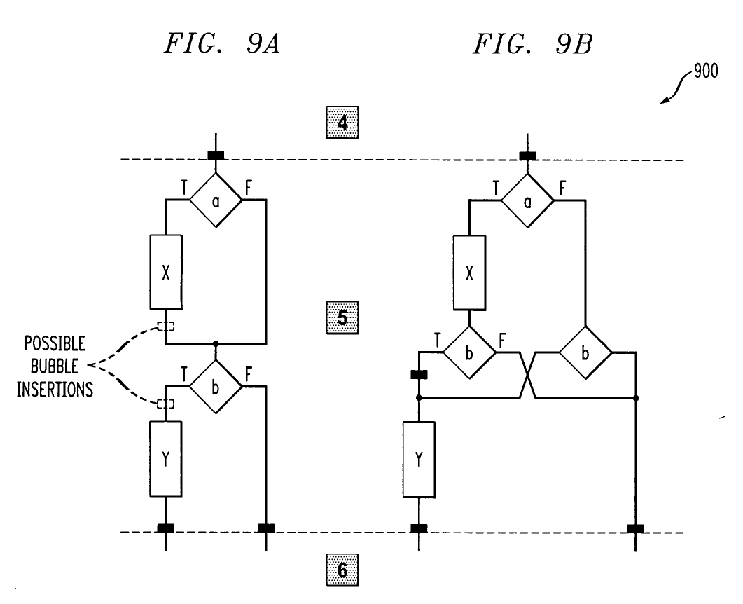

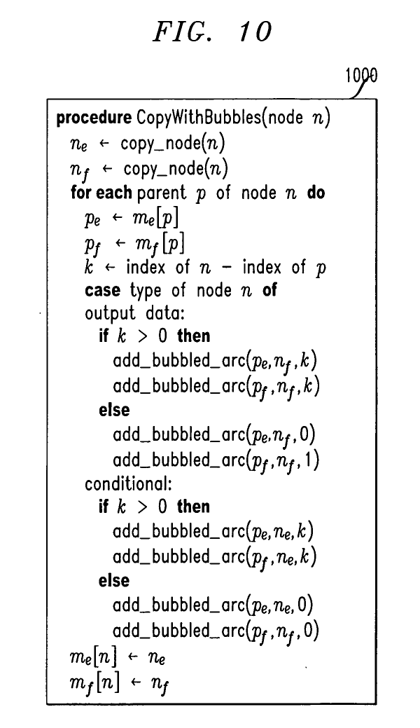

To comply with the first rule, exactly k bubbles are inserted on any arc between nodes with different indices. It is harder to comply with the second rule. FIG. 9 illustrates an example of scheduling inside a read cycle index. In FIG. 9A, the inserted bubbles introduces wasted cycles. In FIG. 9B, the conditional is duplicated. In the example of FIG. 9, the output may comprise X or Y, both X and Y, or neither X or Y, depending on conditions a and b. If both a and b are true, two physical cycles are needed; otherwise, one cycle will suffice. If both a and b are false, the output will idle for one cycle, as the data to follow will not be available.

Following the second rule, a bubble may be inserted in the two positions shown in FIG. 9A. However, if it is inserted under X, if a is true and b is false, two cycles are spent instead of one. Similarly, for the second position, if a is false and b is true. The solution is to reshape the graph by duplicating the second condition, as shown in FIG. 9B.

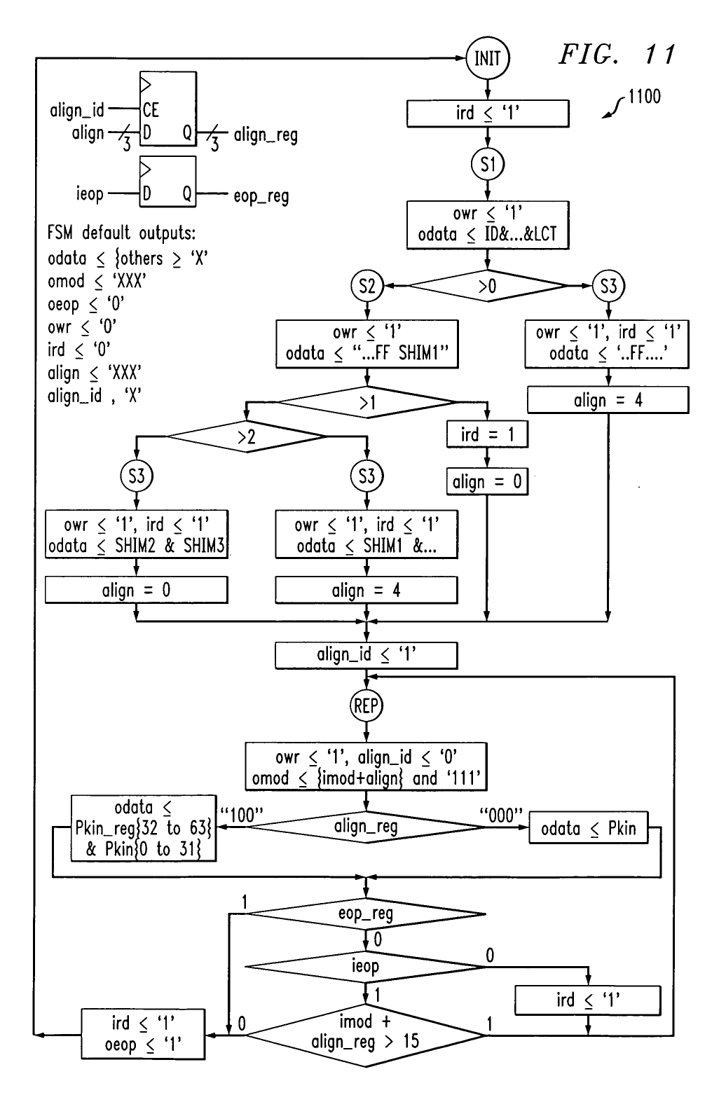

FIG. 10 illustrates exemplary pseudo-code for a bubble-insertion algorithm 1000. For each node in the original graph, two copies are built: nₑ (empty) and n_{f} (full), that handle control flow when the current cycle has and has not been used for data output, respectively. For most nodes, only one copy remains after a sweep that removes unconnected nodes.

E. Synthesizing the Controller

Once the read cycle indices and bubbles have been added in the manner discussed above, the next step is to synthesize the control finite state machine (FSM). The structure of the control finite state machine follows that of the packet map. Bubbles along arcs in the packet map correspond to states; replacing them with registers leads to a one-hot encoding. The topmost bubble is the initial state. Bubbles adjacent to the leaves are special states that repeat copying data until ieop is detected, after which the FSM goes to the initial state.

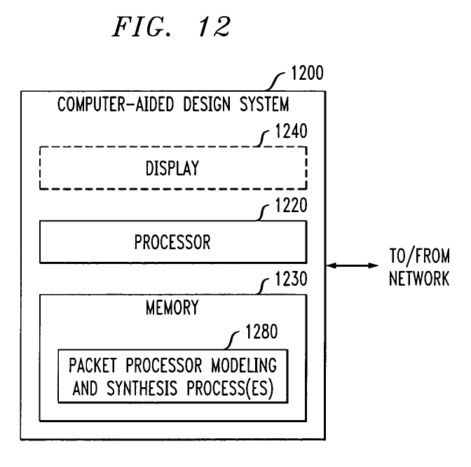

FIG. 11 shows the packet map 800 of FIG. 8 translated into an FSM 1100. When an output node is encountered, the data are steered to the output, and the owr signal is asserted. Scheduling the second rule ensures that at most one output node is found on any path between two states. For paths with no output nodes, owr remains deasserted. For each arc index increase, the ird signal is asserted to read the next word from the buffer. Scheduling rule 1 ensures that at most one word will be read between two states. For paths with no index increase, ird remains de-asserted.

F. Handling the End of a Packet

All paths in the packet map reconverge to no more than w different states in the end, corresponding to alignments ranging from no shifting necessary to shifting w−1 bytes. However, rather than leaving these states separate, the disclosed algorithm merges the end of each path to a common REP state that is accompanied by an auxiliary align register of size log₂ (w). The align register is loaded on any transition that leads to REP.

Using the align register, the REP state performs two tasks. First, it aligns the data using a multiplexer. In FIG. 8, align can take only two values, 0 and 4, demanding a two-input multiplexer. Second, if eop is active, the FSM 1100 can decide by the values of align and imod whether an extra cycle is required to write the last word, in which case the input FIFO must stall.

G. Synthesizing the Data Path

The computational nodes are translated directly into combinational logic; they form the datapath. Furthermore, bubbles are translated into registers to guarantee that any node with read cycle index i has a valid value on that respective cycle.

Since a read cycle index may correspond to several clock cycles, registers must keep their values in such cases. The exemplary embodiment employs a simple approach where all registers hold their value when the present and next state are equal; otherwise they are loaded. A more efficient scheme is possible from noticing that for a register driving a node with index i, the output is “don't care” unless the FSM next state has also index i.

The datapath is pipelined by adding an arbitrary number of registers (usually 1-3) at the module outputs (e.g., odata or owr). These will be likely backward retimed inside the combinational logic by the RTL synthesis tool, because they do not belong to critical sequential cycles, thus improving performance.

When the wrapper 500 asserts the suspend signal, the core module 520 holds all the registers, both in the controller FSM 1100 and in the data path.

FIG. 12 is a block diagram of a computer-aided design system 1200 that can implement the processes of the present invention. As shown in FIG. 12, memory 1230 configures the processor 1220 to implement the circuit for packet processing modeling and synthesis methods, steps, and functions discussed herein (collectively, shown as 1280 in FIG. 12). The memory 1230 could be distributed or local and the processor 1220 could be distributed or singular. The memory 1230 could be implemented as an electrical, magnetic or optical memory, or any combination of these or other types of storage devices. It should be noted that each distributed processor that makes up processor 1220 generally contains its own addressable memory space. It should also be noted that some or all of computer system 1200 can be incorporated into an application-specific or general-use integrated circuit.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for modeling a circuit for packet processing that transforms one or more fields of a packet, comprising:
representing said transformation using a packet editing graph having at least one node.

2. The method of claim 1, wherein said packet editing graph has at least one conditional node, said at least one conditional node having a plurality of output branches, wherein a value of at least one of said fields is determined by selecting a corresponding one of said output branches based on a value of a predicate applied to said conditional node.

3. The method of claim 1, wherein inputs to said packet editing graph comprise said packet and data from a memory lookup.

4. The method of claim 1, wherein said packet editing graph further comprises arithmetic and logical operators.

5. The method of claim 1, wherein said packet editing graph further comprises one or more outputs comprising an output packet and data that generates memory lookup requests.

6. The method of claim 1, wherein said packet editing graph further comprises connections among one or more of inputs, operators and outputs.

7. The method of claim 1, wherein said transformation comprises one or more of adding, removing, modifying and maintaining said at least one field of a packet header.

8. The method of claim 1, further comprising the step of synthesizing a core based on said representation.

9. The method of claim 8, further comprising the step of generating a wrapper function that surrounds said core, wherein said wrapper function identifies packet boundaries using one or more signal flags.

10. The method of claim 9, wherein said wrapper function further comprises one or more signals for controlling one or more of input and output functions.

11. The method of claim 1, further comprising the step of modifying said packet editing graph.

12. The method of claim 11, wherein said modifying step further comprises one or more steps of modifying nodes in said packet editing graph to have a substantially similar size and labeling each node in said packet editing graph with a logical cycle in which its data becomes available.

13. The method of claim 12, wherein said modifying step labels each node in said packet editing graph with one or more delay bubbles that delay one or more fields of said packet.

14. The method of claim 13, wherein at least k of said delay bubbles are added between two adjacent nodes if said logical cycles associated with said adjacent nodes differ by k cycles.

15. The method of claim 13, wherein said delay bubbles are added such that any two output nodes in said packet editing graph have at least one bubble between them.

16. The method of claim 1, further comprising the step of synthesizing a control finite state machine by transforming nodes in said packet editing graph to registers in said control finite state machine.

17. A method for synthesizing a circuit for packet processing that transforms one or more fields of a packet, comprising:
synthesizing a control finite state machine based on a packet editing graph having at least one node, wherein said packet editing graph represents said circuit for packet processing.

18. The method of claim 17, wherein said packet editing graph further comprises at least one conditional node, said at least one conditional node having a plurality of output branches, wherein a value of at least one of said fields is determined by selecting a corresponding one of said output branches based on a value of a predicate applied to said conditional node, and wherein said at least on conditional node is transformed into a multiplexer controlled by said control finite state machine.

19. The method of claim 17 wherein said at least one node in said packet editing graph is transformed into a register in said control finite state machine.

20. The method of claim 17, wherein said packet editing graph further comprises one or more of arithmetic and logical operators that are transformed into one or more combinatorial circuits.

21. The method of claim 17, further comprising the steps of synthesizing a core based on said representation and generating a wrapper function that surrounds said core, wherein said wrapper function identifies packet boundaries using one or more signal flags.

22. An apparatus for modeling a circuit for packet processing that transforms one or more fields of a packet, comprising:
a memory; and
at least one processor, coupled to the memory, operative to:
represent said transformation using a packet editing graph having at least one node.

23. The apparatus of claim 22, wherein said packet editing graph has at least one conditional node, said at least one conditional node having a plurality of output branches, wherein a value of at least one of said fields is determined by selecting a corresponding one of said output branches based on a value of a predicate applied to said conditional node.

24. The apparatus of claim 22, wherein said packet editing graph further comprises arithmetic and logical operators and connections among one or more of inputs, operators and outputs.

25. The apparatus of claim 22, wherein said processor is further configured to synthesize a core based on said representation and generate a wrapper function that surrounds said core, wherein said wrapper function identifies packet boundaries using one or more signal flags and further comprises one or more signals for controlling one or more of input and output functions.

26. The apparatus of claim 22, wherein said processor is further configured to modify said packet editing graph.

27. An apparatus for synthesizing a circuit for packet processing that transforms one or more fields of a packet, comprising:
a memory; and
at least one processor, coupled to the memory, operative to:
synthesize a control finite state machine based on a packet editing graph having at least one node, wherein said packet editing graph represents said circuit for packet processing.

28. The apparatus of claim 27, wherein said packet editing graph has at least one conditional node, said at least one conditional node having a plurality of output branches, wherein a value of at least one of said fields is determined by selecting a corresponding one of said output branches based on a value of a predicate applied to said conditional node, and wherein nodes in said packet editing graph are transformed into registers in said control finite state machine.

29. The apparatus of claim 27, wherein said processor is further configured to synthesize a core based on said representation and generate a wrapper function that surrounds said core, wherein said wrapper function identifies packet boundaries using one or more signal flags.
